(19) United States
(12) Patent Application Publication
(10) Pub. No.: US 2025/0125973 A1
(43) Pub. Date: Apr. 17, 2025

(54) QUANTUM-SAFE DIGITAL SIGNATURE METHOD AND SYSTEM

(71) Applicant: Quantropi Inc., Ottawa (CA)

(72) Inventors: Randy Kuang, Ottawa (CA); Maria Perepechaenko, Ottawa (CA); Dafu Lou, Ottawa (CA)

(73) Assignee: Quantropi Inc., Ottawa (CA)

(21) Appl. No.: 18/916,605

(22) Filed: Oct. 15, 2024

Related U.S. Application Data
(60) Provisional application No. 63/544,259, filed on Oct. 16, 2023.

(51) Int. Cl. H04L 9/32; H04L 9/08

(52) U.S. Cl. CPC H04L 9/3247; H04L 9/0825

(57) ABSTRACT

A method of operating a computing apparatus, which includes receiving a signed message including a digital asset xo and a signature {F, H}. A public key associated with a private key that is unknown to the computing apparatus is received, the public key including sₚ, s_{q}, pᵢⱼ′, qᵢⱼ′, μᵢⱼ and vᵢⱼi=0 to n+λ, j=1 to m, with λ, n and m being predetermined integers. Based on the signature, the public key and the digital asset, it is verified whether the following validation equation holds true:

$${\sum }_{i = 0}^{n + λ} {U}_{i j} ( H ) {{x}_{0}}^{i} = {\sum }_{i = 0}^{n + λ} {V}_{i j} ( F ) {{x}_{0}}^{i} , j = 1 to m , where$$

$${U}_{i j} ( H ) = {{Hp}^{′}}_{i j} - {s}_{p} ⌊ H {μ}_{i j} / R ⌋ mod p$$

$${V}_{i j} ( F ) = {{Fq}^{′}}_{i j} - {s}_{q} ⌊ F {v}_{i j} / R ⌋ mod p$$

In case the validation equation holds true for all j=1 to m, it is concluded that the signature was derived from the digital asset and the private key, and the signature is considered authentic.

### CROSS-REFERENCE TO RELATED APPLICATION

The present application claims the benefit of U.S. Provisional Application Ser. No. 63/544,259 filed on Oct. 16, 2023, hereby incorporated by reference herein.

### FIELD

The present disclosure relates generally to a digital signature method and system and, more particularly, to a method and system for signing and verification that provide a high degree of trustworthiness in the face of powerful cryptanalytic attacks, such as by a quantum computer.

### BACKGROUND

One application of cryptography is a digital signature. For example, a party (e.g., a sender) may securely store a private key that corresponds to a public key. The public key is made easily available to other parties (e.g., a recipient), but the private key is kept secret by the sender. The sender who wishes to sign a message uses its private key to generate a signature from the message. The sender sends the message and the signature to the recipient. The recipient uses the sender's public key to process the message and the signature in order to verify that message is indeed from the sender.

The private key and the corresponding public key can be intertwined in a complex mathematical relationship that is difficult to guess, yet any hypothesis as to the nature of this relationship can be easily tested. In other words, it is easy to tell from the message and the signature whether the sender used the correct private key to sign the message. Yet, without the correct private key, it is difficult for a third party to come up with the signature associated with an arbitrary future message and make it appear that it was from the sender. Difficult, however, but not impossible. In fact, malicious parties throughout the world specialize in reverse engineering mathematical relationships (an act known as “cracking”) to obtain a “cracked key”. A cracked key is any key that can be used to successfully obtain the same signature for a message that would have been obtained by using the sender's private key. In that sense, a cracked key can correspond to the sender's private key but might also be one of possibly several other keys that lead to the same result.

The difficulty of cracking a private key in today's private/public key infrastructure is a function of various factors, such as the complexity of the mathematical relationship, the key length (in bits) and a malicious party's available computing power. The greater the key length and the more complex the mathematical relationship, the more difficult it will be to crack the private key. However, with the advent of quantum computing, the security of a private key previously believed to be uncrackable is now in doubt. Thus, mathematical relationships need to become more complex, and keys need to be made even longer in order for the security of the private key to keep up with increases in computing power available to malicious parties.

However, increases in mathematical complexity and key length are disadvantageous from the perspective that they lead to increases in latency and computational effort. In fact, the mathematical complexity and key lengths that would be required in today's digital signature schemes in order to make a private key acceptably secure against the threat of a quantum computing cryptanalytic attack would bring digital communication over the internet to a standstill.

As such, the industry would welcome a digital signature technique that is highly trustworthy (difficult to forge), is computationally simple and has low latency.

### SUMMARY

Accordingly, there is provided a digital signature system in which a private key for signing and a corresponding public key for verification are generated in accordance with a key generation process to provide enhanced trustworthiness, while requiring relatively low computational complexity to implement, thus finding application in real-time, low-latency, high-speed and/or low-memory environments. Specifically, a digital signature is generated from a digital asset using the specially generated private key. The recipient uses the sender's public key and the received digital asset to determine whether the digital signature is valid. Without the private key, it is extremely difficult for a malicious party to generate a valid signature for a subsequent message ostensibly sent by the sender. The numerical order of difficulty can be higher than what is practical using today's computing devices and even what is expected to be achievable using quantum computers. As such, there is provided a quantum-safe signature and verification process.

Accordingly, there is provided a method of operating a computing apparatus of a method of operating a computing apparatus for verifying authenticity of digital cryptographic communications received from a sending device over a data network, the method comprising:
receiving a signed message from the sending device, the signed message including (i) a digital asset represented by an integer x₀ and (ii) a signature, the signature including data elements represented by integers F and H;
obtaining a public key associated with a private key that is unknown to the computing apparatus, the public key including data elements represented by integers sₚ, s_{q}, pᵢⱼ′, qᵢⱼ′, λᵢⱼ and vᵢⱼ, i=0 to n+λ, j=1 to m, with λ, n and m being predetermined integers stored in a memory of the computing apparatus;
verifying, based on the signature, the public key and the digital asset, whether a validation equation holds true, wherein the validation equation comprises:

$${\sum }_{i = 0}^{n + λ} {U}_{i j} ( H ) {{x}_{0}}^{i} = {\sum }_{i = 0}^{n + λ} {V}_{i j} ( F ) {{x}_{0}}^{i} , j = 1 to m , where$$

$${U}_{i j} ( H ) = {{Hp}^{′}}_{i j} - {s}_{p} ⌊ H {μ}_{i j} / R ⌋ mod p$$

$${V}_{i j} ( F ) = {{Fq}^{′}}_{i j} - {s}_{q} ⌊ F {v}_{i j} / R ⌋ mod p ;$$

wherein p is a predetermined integer stored in the memory of the computing apparatus and wherein R is predetermined power of 2 stored in the memory of the computing apparatus;
in case the validation equation holds true for all values of j=1 to m, concluding that the signature was derived from the digital asset and the private key, whereby the signature is considered authentic;
outputting on a network or storing in the memory of the computing apparatus an indication that the signature is considered authentic.

There is also provided a method of operating a computing apparatus for transmitting cryptographic communications to a verification device over a data network, the method comprising:
obtaining a digital asset x₀;
selecting a variable a belonging to a finite field GFₚ, wherein p is a predetermined integer stored in a memory of the computing apparatus;
computing a signature that includes the data elements F and H, where:

$$\begin{matrix}F = {{R}_{q}}^{- 1} \times [ α f ( {x}_{0} ) mod p ] mod {S}_{q} \\ H = {{R}_{p}}^{- 1} \times [ α h ( {x}_{0} ) mod p ] mod {S}_{p} ,\end{matrix}$$

wherein
   f(·) is a first polynomial;
   h(·) is a second polynomial;
   Rₚ and Sₚ are a first co-prime pair; and
   R_{q} and S_{q} are a second co-prime pair; and
transmitting a signed message to the second computing apparatus over a communication channel, wherein the signed message includes the digital asset x₀ and the signature.

In another aspect, there may also be provided a process for operating a computing apparatus to generate a private-public key pair, the private key for use in a signing process for creating a signed message from a digital asset, the signed message including the digital asset and a signature, and the public key for use in a verification process for authenticating the signature based on the public key, the signature and the digital asset, the process comprising:
a) selecting coefficients of a multivariate base polynomial B(x₀, x₁, . . . , xₘ) of order n for x₀, where n and m are selected integers stored in the memory of the computing apparatus;
b) selecting polynomials f(·) and h(·) of degree λ, where λ is a selected integer stored in the memory of the computing apparatus;
c) constructing a pair of polynomials, p(x₀, x₁, . . . , xₘ) and q (x₀, x₁, . . . , xₘ), by multiplying the base polynomial B(x₀, x₁, . . . , xₘ) with the polynomials f(·) and h(·), respectively:

$$p ( {x}_{0} , {x}_{1} , … , {x}_{m} ) = B ( {x}_{0} , {x}_{1} , … , {x}_{m} ) f ( {x}_{0} ) = {\sum }_{j = 1}^{m} {p}_{j} ( {x}_{0} ) {x}_{j}$$

$$q ( {x}_{0} , {x}_{1} , … , {x}_{m} ) = B ( {x}_{0} , {x}_{1} , … , {x}_{m} ) h ( {x}_{0} ) = {\sum }_{j = 1}^{m} {q}_{j} ( {x}_{0} ) {x}_{j}$$

$$where$$

$${p}_{j} ( {x}_{0} ) = {\sum }_{i = 0}^{n + λ} {p}_{i j} {{x}_{0}}^{i} and {q}_{j} ( {x}_{0} ) = {\sum }_{i = 0}^{n + λ} {q}_{i j} {{x}_{0}}^{i}$$

such that pᵢⱼ and qᵢⱼ are defined as follows:

$$\begin{matrix}{p}_{i j} = \begin{matrix}{Σ}_{s + t = i} & {f}_{s} {b}_{t j}\end{matrix} \\ {q}_{i j} = \begin{matrix}{Σ}_{s + t = i} & {h}_{s} {b}_{t j}\end{matrix}\end{matrix}$$

d) selecting two co-prime pairs (Sₚ, Rₚ) and (S_{q}, R_{q})
e) computing the following:

$$\begin{matrix}{P}_{i j} = {R}_{p} {p}_{i j} mod {S}_{p} \\ {Q}_{i j} = {R}_{q} {q}_{i j} mod {S}_{q}\end{matrix}$$

f) creating the private key as including the following data elements:
the coefficients of the polynomial f(·)
the coefficients of the polynomial h(·)
Sₚ, S_{q}, Rₚ and R_{q}
g) composing the public key as including the following data elements:

$${s}_{p} = β {S}_{p} mod p$$

$${s}_{q} = β {S}_{q} mod p$$

$${p}_{i j}^{′} = β {P}_{i j} mod p$$

$${q}_{i j}^{′} = β {Q}_{i j} mod p$$

$${μ}_{i j} = ⌊ \frac{R {P}_{i j}}{{S}_{p}} ⌋$$

$${v}_{i j} = ⌊ \frac{R {Q}_{i j}}{{S}_{q}} ⌋$$

where:
R is a power of 2, and
β is arbitrarily selected over the finite field GF(p).

There is also provided a non-transitory computer-readable storage medium comprising computer-readable instructions which, when executed by a processing entity of a computing apparatus, cause the computing apparatus to carry out operations to sign a digital asset or authenticate the provenance of a signed digital asset by carrying out one or more of the aforementioned methods or processes.

There is further provided a computing apparatus, comprising:
a memory storing computer-readable instructions;
a processor coupled to the memory and configured to read and execute the computer-readable instructions to carry out a method for verifying authenticity of digital cryptographic communications received from a sending device over a data network, the method comprising:
   receiving a signed message from the sending device, the signed message including (i) a digital asset represented by an integer x₀ and (ii) a signature, the signature including data elements represented by integers F and H;
   obtaining a public key associated with a private key that is unknown to the computing apparatus, the public key including data elements represented by integers sₚ, s_{q}, pᵢⱼ′, qᵢⱼ′, μᵢⱼ and vᵢⱼ, i=0 to n+λ, j=1 to m, with λ, n and m being predetermined integers stored in a memory of the computing apparatus;
   verifying, based on the signature, the public key and the digital asset, whether a validation equation holds true, wherein the validation equation comprises:

$${\sum }_{i = 0}^{n + λ} {U}_{ij} ( H ) {{x}_{0}}^{i} = {\sum }_{i = 0}^{n + λ} {V}_{ij} ( F ) {{x}_{0}}^{i} , j = 1 to m , where$$

$${U}_{ij} ( H ) = {{Hp}^{′}}_{ij} - {s}_{p} ⌊ H {μ}_{ij} / R ⌋ mod p$$

$${V}_{ij} ( F ) = {{Fq}^{′}}_{ij} - {s}_{q} ⌊ {Fv}_{ij} / R ⌋ mod p ;$$

wherein p is a predetermined integer stored in the memory of the computing apparatus and wherein R is predetermined power of 2 stored in the memory of the computing apparatus;
   in case the validation equation holds true for all values of j=1 to m, concluding that the signature was derived from the digital asset and the private key, whereby the signature is considered authentic;
   outputting on a network or storing in the memory of the computing apparatus an indication that the signature is considered authentic.

There is also provided a computing apparatus, comprising:
a memory storing computer-readable instructions;
a processor coupled to the memory and configured to read and execute the computer-readable instructions to carry out a method for transmitting cryptographic communications to a verification device over a data network, the method comprising:
   obtaining a digital asset x₀;
   selecting a variable α belonging to a finite field GFₚ, wherein p is a predetermined integer stored in a memory of the computing apparatus;
   computing a signature that includes the data elements F and H, where:

$$F = {{R}_{q}}^{- 1} \times [ α f ( {x}_{0} ) mod p ] mod {S}_{q}$$

$$H = {{R}_{p}}^{- 1} \times [ α h ( {x}_{0} ) mod p ] mod {S}_{p} ,$$

wherein
   f(·) is a first polynomial;
   h(·) is a second polynomial;
   Rₚ and Sₚ are a first co-prime pair; and
   R_{q} and S_{q} are a second co-prime pair; and transmitting a signed message to the second computing apparatus over a communication channel, wherein the signed message includes the digital asset x₀ and the signature.

### BRIEF DESCRIPTION OF THE DRAWINGS

These and other aspects will best be understood from the following description and with reference to the accompanying drawings in which:

FIG. 1 is a block diagram of a communication system implementing a signing process and a verification process in accordance with a non-limiting embodiment.

FIG. 2 is a flowchart showing steps in an example key generation process for determining the components of a sender's private and public keys, in accordance with a non-limiting embodiment.

FIG. 3 is a flowchart showing steps in an example signing process, in accordance with a non-limiting embodiment.

FIG. 4 is a flowchart showing steps in an example verification process, in accordance with a non-limiting embodiment.

FIG. 5 is a block diagram illustrating possible data structures that could be stored in a memory of a signing computer, a verification computer and a key generation computer, in accordance with a non-limiting embodiment.

FIG. 6 is a table showing an example of benchmark performance.

FIG. 7 is a block diagram of a computing entity representing a possible implementation of a signing computer, a verification computer and/or a key generation computer.

The drawings are intended to aid in understanding certain aspects of the disclosure and are not intended to be limiting.

### DETAILED DESCRIPTION

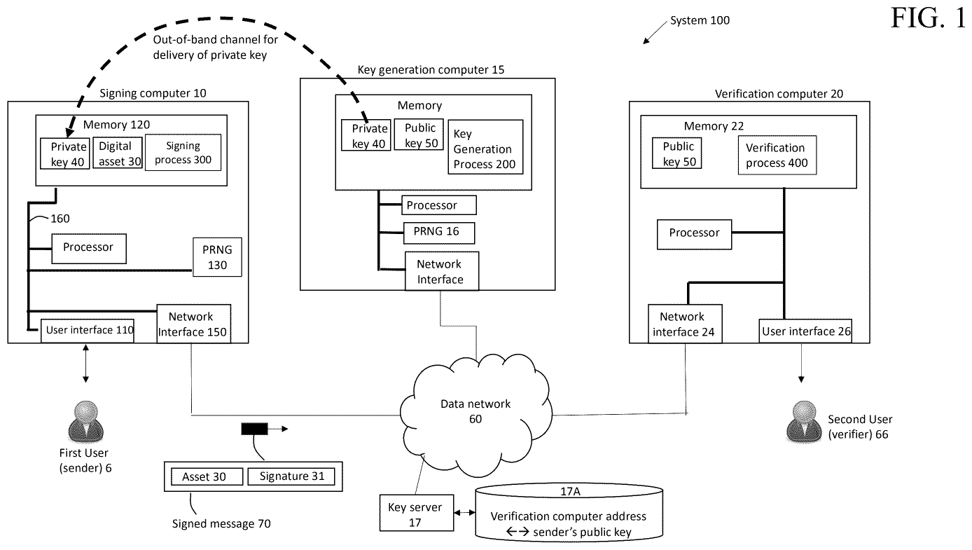

With reference to FIG. 1, there is shown a system 100 that is a practical application of certain methods of generating and using a cryptographic key pair that provide a high degree of security in a digital signature scenario, i.e., they make digital signatures extremely difficult to forge. The cryptographic key pair is used for communications between a first computer 10 and a second computer 20. In a non-limiting embodiment, one or both of the computers 10, 20 may be implemented in a mobile device, a vehicle, an IoT appliance or a laptop/desktop computer communicating over a data network 60 which may traverse the Internet and may include one or more wireless networks. It is worth noting that certain embodiments achieve NIST Level I, Level Ill or even Level V security yet the number of bits taken up by the private and public keys is small, which makes the current approach more suitable than existing approaches where tolerance to latency is low, where bandwidth may be low, where little computational power may be available and/or where computer memory/storage may be at a premium.

The first computer 10 may comprise a user interface 110 for interfacing with a first user 6. The user interface 110 may be a graphical user interface 110 and may be configured to receive and/or elicit information from the first user 6 (e.g., through a keyboard or a touchscreen) and to exhibit and/or output information for the first user 6, e.g., through a display. Analogously, the second computer 20 may comprise a user interface 26 for interfacing with a second user 66. The user interface 26 may be a graphical user interface 26 and may be configured to receive and/or elicit information from the second user 66 (e.g., through a keyboard or a touchscreen) and to exhibit and/or output information for the second user 66, e.g., through a display.

In an embodiment, the first user 6 uses the first computer 10 to send a digital asset 30 to the second user 66 via the second computer 20, and the second user 66 wishes to verify that the received digital asset 30 was indeed sent by the first user 6. As such, the first user 6 is hereinafter referred to as the “sender” and the second user 66 is referred to as the “verifier”. In various non-limiting embodiments, the digital asset 30 may be a file, a document or a message of any kind.

The sender 6 may be associated with a cryptographic key pair comprising a “private key” 40 and corresponding “public key” 50. The sender's cryptographic key pair may be generated in accordance with a pre-determined computing process (described below) that may be carried out locally by the sending computer 10 or remotely by a key generation computer 15. In some embodiments, the key generation computer 15 may store the sender's public key 50 for availability by requesting entities such as the verification computer 20 (or the verifier 66). Specifically, the sender's public key 50 may be stored in a memory of the key generation computer 15 in association with an identity of the sender 6.

The first computer 10 is configured to run a signing process to convert a digital asset 30 into a signed message 70. Accordingly, the first computer 10 is hereinafter referred to as the “signing computer”. In a non-limiting example, the signed message 70 may be a plaintext message including the digital asset 30 itself together with a digital signature 31. The digital signature 31 is generated based on the digital asset 30 and the sender's private key 40. The sender's private key 40 may be stored in a memory at the first computer 10 and may be withheld from other entities such as the second computer 20 and other entities. In contrast, the sender's public key 50 can be made available (e.g., distributed or transmitted over the Internet or another data network or combination of networks) to entities (such as the second computer 20) that may wish to authenticate communications purportedly sent by the sender 6 as being truly sent by the sender 6. The second computer 20 is configured to run a verification process to the signed message 70 using the sender's public key 50, in order to authenticate the provenance of the received signed message 70. Accordingly, the second computer 20 is hereinafter referred to as the “verification computer”.

Due to generation of the cryptographic key pair 40, 50 based on a specific computing process that uses “noise variables” (as will be described herein below), the sender's private key 40 is extremely difficult to derive from the sender's public key 50, even after observing multiple signed messages 70 signed using the same private key 40. This makes the present digital signature scheme highly reliable; in particular, the present digital signature scheme makes it extremely difficult to forge a signature for a digital asset to make it appear to be from a given sender when in reality it is not. Meanwhile, the operations according to which the digital asset 30 is signed to produce the signed message 70 and according to which the digital signature 31 is verified based on the sender's public key 50 are of relatively low computational complexity and relatively low latency.

### Generation of the Cryptographic Key Pair 40, 50

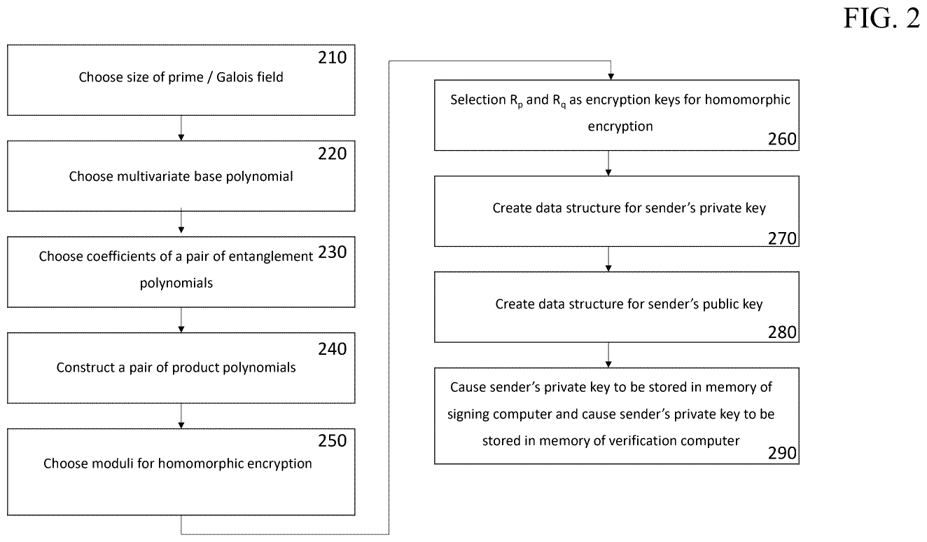

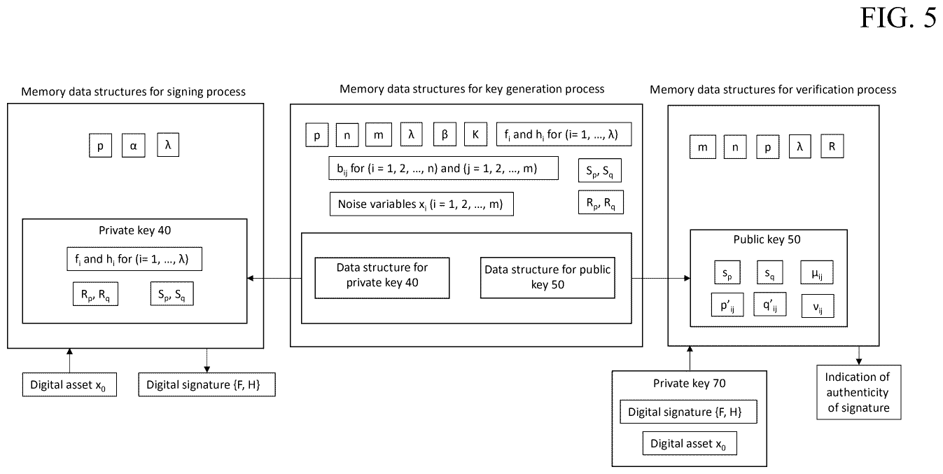

FIG. 2 shows steps in a key generation process 200 for determining the components (data elements) of the sender's private and public keys, in accordance with a non-limiting embodiment. In one embodiment, the key generation process 200 may be carried out by executing computer-readable instructions stored in the memory of the same computing apparatus as implements the signing computer 10. In another embodiment, the key generation process 200 may be carried out by the key generation computer 15 by executing computer-readable instructions in a memory of the key generation computer 15. The key generation computer 15 may be a separate third-party computing apparatus that publishes (or otherwise renders available) the sender's public key 50 over the data network 60 (e.g., to the verification computer 20). The key generation computer 15 may also be configured to provide for secure delivery of the sender's private key 40 to the signing computer 10 (e.g., via out-of-band delivery, i.e., not over the data network 60, although there is nothing form a technological standpoint to prevent delivery of the private key 40 to the signing computer 10 over the data network 60). Reference is also made to FIG. 5.

Some of the steps in the key generation process 200 may include various sub-steps, and not all steps or sub-steps need be performed, or performed in the order described.

### Step 210:

The key generation process 200 includes obtaining from memory an integer p for modulo arithmetic. The integer p can be stored in computer memory using [log₂p] bits. In various embodiments, p can require 6, 8, 10, 12, 14, 16 or more bits based on security requirements. Although in some embodiments, it may be preferable that p be prime, it need not be in all cases. Furthermore, all computations described below are performed as modulo p(“mod p”) unless otherwise indicated (and in some equations “mod p” is shown for emphasis but its absence from other equations does not necessarily suggest that “mod p” is not performed). A modulo computation is an arithmetic operation performed in a computer that finds the remainder when a first integer is divided by a second integer, thus limiting the result to between 0 and one less than the second integer.

### Step 220:

The key generation process 200 includes obtaining from memory a set of data elements that define coefficients of a multivariate base polynomial B(x₀, x₁, . . . , xₘ) of order n for x₀. In some embodiments, n can be pre-selected and stored in the memory of the key generation computer 15. There is no particular limitation on the value of n. Non-limiting examples for the value of n include 1, 2, 3, 4, 5, 6, 7, 8, 9, 10 or higher. Typically, the greater the value of n, the more secure the system 100 will be.

The multivariate base polynomial B(x₀, x₁, . . . , xₘ) can be expressed as:

$$\begin{matrix}B ( {x}_{0} , {x}_{1} , ... , {x}_{m} ) = {\sum }_{i = 0}^{n} {\sum }_{j = 1}^{m} {b}_{ij} {x}_{j} {{x}_{0}}^{i} \\ = {\sum }_{j = 1}^{m} {B}_{j} ( {x}_{0} ) {x}_{j} , where {B}_{j} ( {x}_{0} ) = {\sum }_{i = 0}^{n} {b}_{ij} {{x}_{0}}^{i} ( j = 1 , 2 , ... , m )\end{matrix} .$$

The coefficients of multivariate base polynomial B(x₀, x₁, . . . , xₘ) can thus include the coefficients bᵢⱼ for (i=0, 1, 2, . . . , n) and for (j=1, 2, . . . , m), which can be stored in the memory of the key generation computer 15.

Each Bⱼ(x₀), j=1, 2, . . . , m, is a univariate polynomial in the variable x₀, and the x1 . . . , xₘcan be referred to as “noise variables” (or permutation data elements), of which there are m. The multivariate base polynomial B(x₀, x₁, . . . , xₘ) can therefore be considered a linear combination of m univariate polynomials Bⱼ(x₀), j=1, 2, . . . , m, with the coefficients of the linear combination corresponding to the noise variables x₁. . . , xₘ.

The value of m (i.e., the number of noise variables) is a secure parameter that can be arbitrarily set to any positive integer based on the security level, without any particular constraint except for security considerations, i.e., the higher the value of m, the greater the security level, all other variables being equal. Non-limiting examples for the value of m include 1, 2, 3, 4, 5, 6, 7, 8, 9, 10 or higher.

The values of m and n may be stored in the memory of the key generation computer 15.

### Step 230:

The key generation process 200 includes choosing the coefficients of a pair of entanglement polynomials f(·) and h(·) of degree λ:

$$f ( {x}_{0} ) = {\sum }_{i = 0}^{λ} {f}_{i} {{x}_{0}}^{i}$$

$$h ( {x}_{0} ) = {\sum }_{i = 0}^{λ} {h}_{i} {{x}_{0}}^{i}$$

By keeping the order of each of the entanglement polynomials f(·) and h(·) relatively low (such as by keeping λ equal to 1, 2 or 3, for example), these polynomials will have analytically derivable roots. The value of λ may be stored in the memory of the key generation computer 15.

The values of the fᵢ and the hᵢ(i=0, 1, 2, . . . , λ) can be chosen arbitrarily such as from the output of a pseudo-random number generator 16 implemented by the key generation entity 15. The values are selected over the finite field GF(p), which is a prime finite field GF(p) if p is prime.

### Step 240:

The key generation process 200 includes constructing a pair of product polynomials, p(x₀, x₁, . . . , xₘ) and q(x₀, x₁, . . . , xₘ), by multiplying the base polynomial B(x₀, x₁, . . . , xₘ) with the (univariate) entanglement polynomials f(·) and h(·), respectively:

$$\begin{matrix}p ( {x}_{0} , {x}_{1} , ... , {x}_{m} ) = B ( {x}_{0} , {x}_{1} , ... , {x}_{m} ) f ( {x}_{0} ) \\ = {\sum }_{j = 1}^{m} {p}_{j} ( {x}_{0} ) {x}_{j}\end{matrix} , \qquad ( EQ . 1 A )$$

$$Where {p}_{j} ( {x}_{0} ) = {\sum }_{i = 0}^{n + λ} {p}_{ij} {{x}_{0}}^{i}$$

$$and$$

$$\begin{matrix}q ( {x}_{0} , {x}_{1} , ... , {x}_{m} ) = B ( {x}_{0} , {x}_{1} , ... , {x}_{m} ) h ( {x}_{0} ) \\ = {\sum }_{j = 1}^{m} {q}_{j} ( {x}_{0} ) {x}_{j}\end{matrix} , \qquad ( EQ . 1 B )$$

$$where {q}_{j} ( {x}_{0} ) = {\sum }_{i = 0}^{n + λ} {q}_{ij} {{x}_{0}}^{i} ,$$

From the above it will be apparent that pᵢⱼ and qᵢⱼ are defined as follows:

$${p}_{ij} = {\sum }_{s + t = i} {f}_{s} {b}_{tj} and$$

$${q}_{ij} = {\sum }_{s + t = i} {h}_{s} {b}_{tj} .$$

### Step 250:

The key generation process 200 includes choosing two values Sₚ and S_{q} with a bit length lₛ>=2*log₂p+log₂[m(n+λ+1)] as moduli for homomorphic encryption. Sₚ and S_{q} can be randomly generated (e.g., as the output of the pseudo-random number generator 16), as long as they obey the aforementioned constraint that the number of bits needed to express Sₚ and S_{q} is at least as great as the sum of twice the number of bits needed to express p and the number of bits needed to express the product of m and (n+λ+1).

### Step 260:

The key generation process 200 includes the selection of two numbers Rₚ and R_{q} as encryption keys for homomorphic encryption, such that GCD(Rₚ,Sₚ)=1 and GCD(R_{q},S_{q})=1, i.e., Rₚ and R_{q} are coprime with the respective chosen modulus.

The key generation process 200 includes computing the following:
Pᵢⱼ=Rₚ pᵢⱼ mod Sₚ and
Qᵢⱼ=R_{q} qᵢⱼ mod S_{q}.

This also gives the following polynomials P(·) and Q(·):

$$P ( {x}_{0} , {x}_{1} , ... , {x}_{m} ) = {\sum }_{j = 1}^{m} {\sum }_{i = 0}^{n + λ} {P}_{ij} {{x}_{0}}^{i} {x}_{j} , and$$

$$Q ( {x}_{0} , {x}_{1} , ... , {x}_{m} ) = {\sum }_{j = 1}^{m} {\sum }_{i = 0}^{n + λ} {Q}_{ij} {{x}_{0}}^{i} {x}_{j} .$$

### Step 270:

The key generation process 200 includes creating a data structure in the memory that includes the sender's private key 40. The data structure for the sender's private key 40 may be populated by the following data elements:
the coefficients of f(·) (i.e., f₀, f₁, . . . , f_{λ});
the coefficients of h(·) (i.e., h₀, h₁, . . . , h_{λ}); and
Sₚ, S_{q}, Rₚ and R_{q} (see steps 250 and 260).

### Step 280:

The key generation process 200 includes creating a data structure in the memory that includes the sender's public key 50. The data structure for the sender's public key 50 may be populated by the following data elements:

$${s}_{p} = β {S}_{p} mod p ,$$

$${s}_{q} = β {S}_{q} mod p ,$$

$${{p}^{′}}_{ij} = β {P}_{ij} mod p ,$$

$${{q}^{′}}_{ij} = β {Q}_{ij} mod p ,$$

$${μ}_{ij} = ⌊ \frac{{RP}_{ij}}{{S}_{p}} ⌋ , and$$

$${v}_{ij} = ⌊ \frac{{RQ}_{ij}}{{S}_{q}} ⌋ ,$$

where:
R=2^{K} and K is selected to be >>lₛ (where lₛ was defined as in step 250), and
β is arbitrarily selected over the finite field GF (p). For example, β can be selected at random, e.g., using a pseudo-random number generator. It is noted that β may enhance security, by making the public key data elements sₚ, s_{q}, p′ᵢⱼ and q′ᵢⱼ not directly associated with Sₚ, S_{q}, Pᵢⱼ and Qᵢⱼ, respectively.
Further details about the data elements of the sender's public key 50 will be provided below in the section entitled “Explanation”.

### Step 290:

The key generation process 200 may include causing the sender's private key 40 to be securely stored in a memory of the signing computer 10. For example, if the key generation process 200 is executed by the key generation computer, the key generation computer 15 may be configured to communicate the sender's private key 40 to the signing computer 10 over the data network 60, over another network that is not the data network 60 or over an out-of-band connection. In another embodiment, the key generation process 200 is carried out by the signing computer 10 itself, in which case the above steps attributed to the key generation computer 15 are actually performed by the signing computer 10.

The key generation process 200 may also cause the sender's public key 50 to be made available to would-be verifiers such as the verification computer 20. This can be done by sending the sender's public key 50 to the verification computer 20 over the data network 60 or by sending the sender's public key 50 to a key computer 17, which may be a web computer 17 reachable over the data network 60. The key computer 17 may store a database 17A in which a network address of the verification computer 20 (e.g., an internet address or URL) is associated with the sender's public key 50. In this way, the sender's public key 50 can be accessible to entities such as the verification computer 20. However, the sender's private key 40 remains withheld from the verification computer 20.

### Signing Process

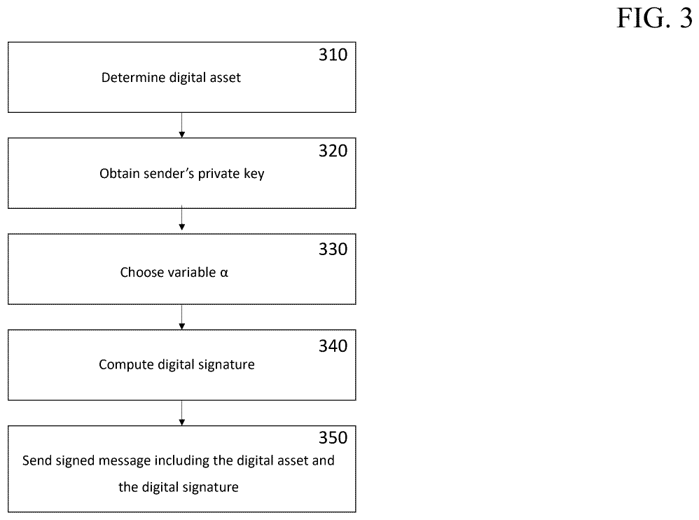

Based on the sender's private key 40 as defined above, the signing computer 10 may perform a signing process 300 in accordance with a non-limiting embodiment, now described with reference to FIGS. 3 and 5. Some steps in the signing process 300 may include various sub-steps, and not all steps or sub-steps need be performed, or performed in the order described.

### Step 310:

The signing computer 10 determines a digital asset x₀. In one embodiment, the digital asset x₀ may be retrieved from the memory 120 of the signing computer 10. In such a scenario, the digital asset x₀ may comprise a file, image, video, message or other data element stored in a non-transitory medium. The digital asset x₀ may represent a document, transaction, financial instrument or other information that the sender 6 wishes to convey to the verifier 66. In some embodiments, the digital asset x₀ may be obtained from the sender 6 by the sender 6 inputting the digital asset x₀ via the user interface 110, such as a graphical user interface.

In an embodiment, the digital asset x₀ is converted to or represented by an integer value from 1 to p−1. If the digital asset x₀ is larger than p−1, it may be segmented into multiple sub-messages of size no greater than p−1. It is recalled that p can be expressed using a certain number of bits, such as 8, 16, 32, 64 or more (or any number of bits in between, depending on operational considerations). The value of p is known both to the signing computer 10 and the verification computer 20. At the signing computer 10, the value of p may be stored in the memory 120. It is noted that for the integer p to be known to the signing computer 10 and the verification computer 20, the integer p can be part of the sender's public key 50 or it can be a security parameter publicly available (e.g., on the web) to the signing computer 10 and other participants in the system, such as the verification computer 20. The integer p may be odd or even, prime or compound. In some cases, it may be preferable for p to be a prime for security considerations. For example, if p is represented using b bits, then p could be the largest prime less than 2^{b}. An example is the largest prime number of a 64-bit field (which is p=2⁶⁴−59=18,446,744,073,709,551,557). Taking p to be prime, particularly a large prime number, might improve performance and/or security.

### Step 320:

The signing computer 10 obtains (e.g., accesses from memory) the sender's private key 40 which, as stated above, comprises:
the coefficients of f(·) (i.e., f₀, f₁, . . . , f_{λ});
the coefficients of h(·) (i.e., h₀, h₁, . . . , h_{λ}); and
co-prime pairs (Sₚ, Rₚ) and (S_{q}, R_{q}).

### Step 330:

The signing computer 10 chooses a variable a, which is arbitrarily selected over the finite field GF(p). A pseud-random number generator can be used for this purpose, for example.

### Step 340:

The signing computer 10 computes the following quantities, recalling that x₀ represents the digital asset:

$$F = {{R}_{q}}^{- 1} [ α f ( {x}_{0} ) mod p ] mod {S}_{q} , and$$

$$H = {{R}_{p}}^{- 1} [ α h ( {x}_{0} ) mod p ] mod {S}_{p} .$$

The digital signature (previously denoted 31) is then a lossless combination of F and H, represented as {F, H}. For example, the digital signature could be a concatenation of F and H. In the event of multiple segments of the digital asset x₀, each such segment would result in its own corresponding digital signature. However, the present non-limiting example considers a digital signature x₀ formed of a single segment with a single corresponding digital signature {F, H}.

### Step 350:

The signing computer 10 sends a signed message 70 containing the digital asset x₀ (previously denoted 30) and the digital signature {F, H} (previously denoted 31) to the verification computer 20. This can be done by sending a packet over the data network 160 via the network interface 150. The packet may have as a destination address an address of the verification computer 20. On its way from the signing computer 10 to the verification computer 20, the packet including the signed message 70 may traverse the data network 60 (e.g., the Internet) and other networks.

### Verification Process

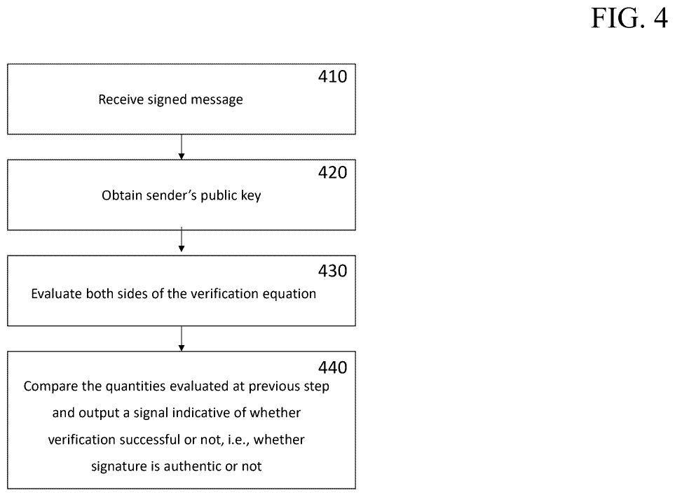

In order to verify that the digital signature {F, H} is indeed that of the sender 6, the verification computer 20 may perform a verification process 400 in accordance with a non-limiting embodiment, now described with reference to FIGS. 4 and 5. Some steps in the verification process 400 may include various sub-steps, and not all steps or sub-steps need be performed, or performed in the order described. It is noted that the verification computer 20 knows the values of p, n, λ and R (=2^{K}, where K>>l_{S}) in advance, and these values may be stored in its memory.

### Step 410:

The verification process 400 includes receiving the signed message 70 containing the digital asset x₀ and the digital signature {F, H}. The signed message 70 may be received over a network interface 24 that connects the verification computer 20 to the data network 60.

### Step 420:

As the signed message 70 was purportedly sent by the sender 6, the verification process 400 includes obtaining the sender's public key 50. The sender's public key 50 may be obtained from the key generation computer 15, from a key computer 17 or may even be included with or appended to the signed message 70. The sender's public key 50 may be obtained in advance of the signed message 70 having been sent by the signing computer 10 or received by the verification computer 20.

### Step 430:

The verification process 400 includes evaluating the following quantities, based on the sender's public key 50, the digital asset x₀ and the digital signature {F, H}:

$${\sum }_{i = 0}^{n + λ} {V}_{ij} ( F ) {{x}_{0}}^{i} and$$

$${\sum }_{i = 0}^{n + λ} {U}_{ij} ( H ) {{x}_{0}}^{i}$$

where:

$${V}_{ij} ( F ) = [ {FQ}_{ij} mod {S}_{q} ] mod p = {{Fq}^{′}}_{ij} - {s}_{q} ⌊ F \frac{{v}_{ij}}{R} ⌋ mod p , and$$

$${U}_{ij} ( H ) = [ {HP}_{ij} mod {S}_{p} ] mod p = {{Hp}^{′}}_{ij} - {s}_{p} ⌊ H \frac{{μ}_{ij}}{R} ⌋ mod p .$$

It is noted that sₚ, s_{q}, Sₚ, S_{q}, μᵢⱼ and vᵢⱼ are all data elements forming part of the sender's public key 50.

### Step 440:

The verification process 400 includes comparing the two quantities computed at step 430, namely Σᵢ₌₀^{n+λ} Vᵢⱼ(F) x₀ⁱ and Σᵢ₌₀^{n+λ} Uᵢⱼ(H) x₀ⁱ. If they match for all j=1, . . . , m, verification is successful, i.e., it is confirmed that the digital asset x₀ was indeed signed using the sender's private key 40, which authenticates provenance of the digital asset x₀. Otherwise, verification fails, and the digital signature {F, H} is declared a forgery. In the case of multiple signature segments, the comparing process must be performed for each segment, any segment failed verification leads the entire signature verification to be failed.

A signal indicating whether verification was successful or not can be communicated to the verifier 66 via the user interface 26 (which can be a graphical user interface). In another embodiment, an indication of whether verification was successful can be packaged in a message sent over a data network (such as the data network 60). In yet another embodiment, the indication of whether verification was successful can be stored in the non-transitory memory 22 of the verification computer 20.

### Explanation

Consideration is now given to explaining why it is the case that when Σᵢ₌₀^{n+λ} Vᵢⱼ(F) x₀ⁱ equals Σᵢ₌₀^{n+λ} Uᵢⱼ(H) x₀ⁱ, this demonstrates that the digital signature {F, H} was indeed derived from the digital asset x₀ and the private key of the purported sender whose public key 50 is available to the verifier 66.

In particular, it will be shown how a verification equation that involves the sender's private key 40 and the digital asset x₀ can be rewritten as a verification equation that involves the sender's public key 50, the digital asset x₀ and the digital signature {F, H}, but does not involve the sender's private key 40.

Specifically, one can recall that:

$$p ( {x}_{0} , {x}_{1} , ... , {x}_{m} ) = B ( {x}_{0} , {x}_{1} , ... , {x}_{m} ) f ( {x}_{0} ) mod p \qquad ( EQ . 1 A )$$

$$and$$

$$q ( {x}_{0} , {x}_{1} , ... , {x}_{m} ) = B ( {x}_{0} , {x}_{1} , ... , {x}_{m} ) h ( {x}_{0} ) mod p . \qquad ( EQ . 1 B )$$

This implies that:

$$p ( {x}_{0} , {x}_{1} , ... , {x}_{m} ) h ( {x}_{0} ) = q ( {x}_{0} , {x}_{1} , ... , {x}_{m} ) f ( {x}_{0} ) mod p . \qquad ( EQ . 2 )$$

It is noted that equation (EQ. 2) involves the coefficients of f(·) and the coefficients of h(·), which are data elements of the sender's private key 40, and thus the verification equation cannot be verified by the verification computer 20. However, by transforming and rearranging equation (EQ. 2) above, one will arrive at a verification equation (see equation (EQ. 8), below) that involves the data elements of the sender's public key 50 and the digital signature, but no longer involves any of the data elements of the sender's private key 40.

Specifically, consider the homomorphic encryption operator ε_{(R,S)} with a generic coprime pair R, S and the related homomorphic decryption operator ε_{(R,S)}⁻¹, acting on a generic polynomial f, as follows:

$${ε}_{( R , S )} [ f ] = ( Rf ) mod S , and$$

$${{ε}_{( R , S )}}^{- 1} [ f ] = ( {R}^{- 1} f ) mod S ,$$

from which it is easy to verify that ε_{(R,S)} is unitary and reversible, i.e., ε_{(R,S)}⁻¹Σ_{(R,S)}=1. (See, for example, Kuang R, Perepechaenko M. A novel homomorphic polynomial public key encapsulation algorithm [version 1; peer review: awaiting peer review]. F1000Research. 2023;12:1347. doi: 10.12688/f1000research.133031.1 and Kuang R, Perepechaenko M. Homomorphic polynomial public key encapsulation over two hidden rings for quantum-safe key encapsulation. Quantum Inf Process. 2023;22:315. doi: 10.1007/s11128-023-04064-4, hereby incorporated by reference herein.)

Taking advantage of the unitary and reversible nature of ε_{(R,S)}⁻¹Σ_{(R,S)}=1 mod S, and for an arbitrarily selected α in GF(p), and utilizing the data elements Rₚ, R_{q}, Sₚ, S_{q} of the sender's private key 40, one can rewrite equation (EQ. 2) as:

$$\{ [ α f ( {x}_{0} ) mod p ] [ {{ε}_{( Rq , Sq )}}^{- 1} {ε}_{( Rq , Sq )} mod {S}_{q} ] q ( {x}_{0} , {x}_{1} , ... , {x}_{m} ) mod p = \{ [ α h ( {x}_{0} ) mod p ] [ {{ε}_{( Rp , Sp )}}^{- 1} {ε}_{( Rp , Sp )} mod {S}_{p} ] p ( {x}_{0} , {x}_{1} , ... , {x}_{m} ) mod p .$$

This equation is then organized as:

$$\{ [ {ε}_{{( Rq , Sq )}^{- 1}} [ α f ( {x}_{0} ) mod p ] mod {S}_{q} ] [ [ {ε}_{( Rq , Sq )} q ( {x}_{0} , {x}_{1} , … , {x}_{m} ) mod {S}_{q} ] mod p \} = \{ {ε}_{{( Rq , Sq )}^{- 1}} [ α h \{ {x}_{0} ) mod p ] mod {S}_{q} ] [ [ {ε}_{( Rq , Sq )} p ( {x}_{0} , {x}_{1} , … , {x}_{m} ) mod {S}_{q} ] mod p \} .$$

Expanding the homomorphic operators, one obtains:

$$\{ {R}_{q}^{- 1} [ α f \{ {x}_{0} ) mod p ] mod {S}_{q} \} \{ [ {R}_{q} q ( {x}_{0} , {x}_{1} , … , {x}_{m} ) mod {S}_{q} ] mod p \} = \{ {R}_{p}^{- 1} [ α h ( {x}_{0} ) mod p ] mod {S}_{q} \} \{ [ {R}_{q} p ( {x}_{0} , {x}_{1} , … , {x}_{m} ) mod {S}_{q} ] mod p \} .$$

Recalling from before that Pᵢⱼ=Rₚ pᵢⱼ mod Sₚ and Qᵢⱼ=R_{q} qᵢⱼ mod s_{q}, and recalling the definitions of p(·) and q(·) in equations (EQ. 1A) and (EQ. 1B), one obtains:

$$[ F \overline{Q} mod {S}_{q} ] mod p = [ H \overline{P} mod {S}_{p} ] mod p , \qquad ( EQ . 3 )$$

where:

$$F = {R}_{q}^{- 1} [ α f ( {x}_{0} ) mod p ] mod {S}_{q} ,$$

$$H = [ α h ( {x}_{0} ) mod p ] mod {S}_{p} ,$$

$$\overline{P} = {\sum }_{j = 1}^{m} {\sum }_{i = 0}^{n + λ} {P}_{ij} ( {x}_{j} {x}_{0}^{i} mod p ) , and$$

$$\overline{Q} = {\sum }_{j = 1}^{m} {\sum }_{i = 0}^{n + λ} {Q}_{ij} ( {x}_{j} {x}_{0}^{i} mod p ) .$$

It is noted that F and H are the components of the digital signature {F, H} created from the private key data elements f(·), h(·), Rₚ, R_{q}, Sₚ and S_{q}. Whereas the digital signature {F, H} is sent to the verification computer 20, the the private key data elements f(·), h(·), Rₚ, R_{q}, Sₚ and S_{q} are not.

With that in mind, equation (EQ. 3) still includes Sₚ and s_{q}, which are data components of the sender's private key 40. To use this equation for verification and allow a verifier to perform evaluations, we must eliminate these private key data elements from the equation. As such, (EQ. 3) can be rewritten as follows:

$${\sum }_{j = 1}^{m} {\sum }_{i = 0}^{n + λ} [ F {Q}_{ij} mod {S}_{q} ] {x}_{0}^{i} {x}_{j} mod p = {\sum }_{j = 1}^{m} {\sum }_{i = 0}^{n + λ} [ H {P}_{ij} mod {S}_{p} ] {x}_{0}^{i} {x}_{j} mod p \qquad ( EQ . 4 )$$

This can be further rewritten as:

$$( EQ . 5 )$$

$${\sum }_{j = 1}^{m} ( {\sum }_{i = 0}^{n + λ} {V}_{ij} ( F ) {x}_{0}^{i} ) {x}_{j} mod p = {\sum }_{j = 1}^{m} ( {\sum }_{i = 0}^{n + λ} {U}_{ij} ( H ) {x}_{0}^{i} ) {x}_{j} mod p ,$$

where:

$${V}_{ij} ( F ) = [ F {Q}_{ij} mod {S}_{q} ] mod p , and \qquad ( EQ . 6 V )$$

$${U}_{ij} ( H ) = [ H {P}_{ij} mod {S}_{p} ] mod p . \qquad ( EQ . 6 U )$$

One can rewrite equation (EQ. 5) as follows:

$${\sum }_{j = 1}^{m} {V}_{j} ( {x}_{0} ) {x}_{j} mod p = {\sum }_{j = 1}^{m} {U}_{j} ( {x}_{0} ) {x}_{j} mod p , \qquad ( EQ . 7 U )$$

$$where$$

$${U}_{j} ( xo ) = {\sum }_{i = 0}^{n + λ} {U}_{ij} ( H ) {x}_{0}^{i}$$

$${V}_{j} ( xo ) = {\sum }_{i = 0}^{n + λ} {V}_{ij} ( F ) {x}_{0}^{i} \qquad ( EQ . 7 V )$$

are coefficients of respective verification polynomials U and V, and where, still as before:

$${U}_{ij} ( H ) = [ H {P}_{ij} mod {S}_{p} ] mod p , and \qquad ( EQ . 6 U )$$

$${V}_{ij} ( F ) = [ F {Q}_{ij} mod {S}_{q} ] mod p . \qquad ( EQ . 6 V )$$

It is noted that verification would be considered successful if the respective coefficients of the two verification polynomials U and V can be shown to be identical to one another, i.e., if it can be shown that Uⱼ(x₀)=Vⱼ(x₀), for j=1 to m. Based on (EQ. 7U) and (EQ. 7B), this is equivalent to saying that verification would be considered successful if it can be shown that:

$${\sum }_{i = 0}^{m} {U}_{ij} ( H ) {x}_{0}^{i} = {\sum }_{i = 0}^{n + λ} {V}_{ij} ( F ) {x}_{0}^{i} , for all j = 1 to m \qquad ( EQ . 8 )$$

$$where$$

$${U}_{ij} ( H ) = [ H {P}_{ij} mod {S}_{p} ] mod p . \qquad ( EQ . 6 U )$$

$${V}_{ij} ( F ) = [ F {Q}_{ij} mod {S}_{q} ] mod p , and \qquad ( EQ . 6 V )$$

Equation (EQ. 8) can be referred to as the verification equation. However, the Uᵢⱼ(H) and Vᵢⱼ(F) terms in (EQ. 6U) and (EQ. 6V) above still cannot be directly computed by the verifier 66 or the verification computer 20 due to the private nature of moduli Sₚ and s_{q}, i.e., they are not accessible to the verifier 66 or the verification computer 20.

To this end, the so-called Barrett transformation offers a solution, enabling the transformation of modular multiplications into divisions, according to the following principle, referred to as the Barrett transformation (note: in the below, n is generally a modulus used in the Barrett algorithm, not to be confused with n, the order of multivariate base polynomial B(x₀, x₁, . . . , xₘ)):

$$( EQ . 9 )$$

$$z = ab mod n = ab - n ⌊ ab / n ⌋ = ab - n ⌊ ( a ⌊ Rb / n ⌋ ) / R ⌋ = ab - n ⌊ ( a μ ) / R ⌋ ,$$

where:
μ= [symbol] Rb/n┘ is a “Barrett parameter” and
R=2^{K}, with K>>log₂n.

Use of the Barrett transformation can help enhance the efficiency of modular multiplications, since μcan be precomputed. The outcome z generated by the Barrett transformation typically falls within the range of [0, 2n) but not consistently within [0, n). Therefore, if the result exceeds n, it necessitates returning z−n. Notably, it has been observed that the occurrence of z>n cases can be mitigated by increasing K to make it >>lₛ. Mathematically, the outcome z accurately falls into [0, n) when K=2 log₂n. Testing by the inventors indicates that when k−┌log₂n┐>30, the instances of z>n tend to approach zero after 100,000,000 trials.

Using equation (EQ. 9), i.e., the Barrett transformation, and multiplying a randomly chosen B, and also performing modular arithmetic operations with mod p, one can rewrite Uᵢⱼ(H) and Vᵢⱼ(F) from (EQ. 6U) and (EQ. 6V). Specifically, one can rewrite

$${U}_{ij} ( H ) = [ H {P}_{ij} mod {S}_{p} ] mod p \qquad ( EQ . 6 U )$$

$$and$$

$${V}_{ij} ( F ) = [ F {Q}_{ij} mod {S}_{q} ] mod p \qquad ( EQ . 6 V )$$

$$as$$

$${U}_{ij} ( H ) = {Hp}_{ij}^{′} - {s}_{p} [ H {u}_{ij} / R ] mod p \qquad ( EQ . 10 U )$$

$$and$$

$${V}_{ij} ( F ) = {Fq}_{ij}^{′} - {s}_{q} [ F {v}_{ij} / R ] mod p \qquad ( EQ . 10 V )$$

where the parameters used in equations (EQ. 10U) and (EQ. 10V) are defined as follows:

$${s}_{p} = β {S}_{p} mod p ,$$

$${s}_{q} = β {S}_{q} mod p ,$$

$${p}_{ij}^{′} = β {P}_{ij} mod p ,$$

$${q}_{ij}^{′} = β {Q}_{ij} mod p ,$$

$${μ}_{ij} = ⌊ \frac{R {P}_{ij}}{{S}_{p}} ⌋ , and$$

$${v}_{ij} = ⌊ \frac{R {Q}_{ij}}{{S}_{q}} ⌋ .$$

In other words, the verification equation remains equation (EQ. 8) but with the rewritten forms of Uᵢⱼ(H) and Vᵢⱼ(F) from (EQ. 10U) and (EQ. 10V):

$${\sum }_{i = 0}^{n + λ} {U}_{ij} ( H ) {x}_{0}^{i} = {\sum }_{i = 0}^{n + λ} {V}_{ij} ( F ) {x}_{0}^{i} , for all j = 1 to m \qquad ( EQ . 8 )$$

where, as before:

$${U}_{ij} ( H ) = {Hp}_{ij}^{′} - {s}_{p} ⌊ H {μ}_{ij} / R ⌋ mod p \qquad ( EQ . 10 U )$$

$${V}_{ij} ( F ) = {Fq}_{ij}^{′} - {s}_{q} ⌊ F {v}_{ij} / R ⌋ mod p \qquad ( EQ . 10 V )$$

It is noted that the parameters (sₚ, s_{q}, p′ᵢⱼ, q′ᵢⱼ, μᵢⱼ and vᵢⱼ) used to evaluate Uᵢⱼ(H) and Vᵢⱼ(F) in equations (EQ. 10U) and (EQ. 10V) are precisely the data elements of the sender's public key 50, whereas F and H are the components of the digital signature. Of note is the fact that all of these data elements, as well as the parameter R, are accessible to the verification computer 20, which therefore allows the verification computer 20 to determine whether verification equation (EQ. 8) holds true.

It is also noted that the arbitrarily chose variable B enhances security by making the public key data elements sₚ, s_{q}, p′ᵢⱼ and q′ᵢⱼ not directly associated with Sₚ, S_{q}, Pᵢⱼ and Qᵢⱼ, respectively.

It is further noted that the public key data elements pᵢⱼ and vᵢⱼ, derived from the Barrett transformation, exhibit nonlinear relationships with the signature elements F and H at the message value x₀. This inherent nonlinearity may be helpful in preventing the creation of forged signatures.

### SIMPLIFIED NUMERICAL EXAMPLE

### Key Generation

Consider a prime finite (or Galois) field GF(13). Let the sender's private key 40 be selected arbitrarily as:

$$f ( {x}_{0} ) = 4 + 9 {x}_{0}$$

$$h ( {x}_{0} ) = 10 + 7 {x}_{0}$$

$${S}_{p} = 6797$$

$${S}_{q} = 7123$$

$${R}_{p} = 4267$$

$${R}_{q} = 6475$$

Let the base polynomial B(·) randomly or arbitrarily generated for this example be

$$B ( {x}_{0} , {x}_{1} , {x}_{2} ) = ( 8 + 7 {x}_{0} ) {x}_{1} + ( 5 + 11 {x}_{0} ) {x}_{2} .$$

This leads to the following product polynomials:

$$p ( {x}_{0} , {x}_{1} , {x}_{2} ) = f ( x ) B ( {x}_{0} , {x}_{1} , {x}_{2} ) = ( 6 + 9 {x}_{0} + 11 {{x}_{0}}^{2} ) {x}_{1} + ( 7 + 11 {x}_{0} + 8 {{x}_{0}}^{2} ) {x}_{2} mod 13$$

$$q ( {x}_{0} , {x}_{1} , {x}_{2} ) = h ( x ) B ( x , {x}_{1} , {x}_{2} ) = ( 2 + 9 {x}_{0} + 10 {{x}_{0}}^{2} ) {x}_{1} + ( 11 + 2 {x}_{0} + 12 {{x}_{0}}^{2} ) {x}_{2} mod 13.$$

Encrypting p(·) and q(·) with the selected Rₚ, R_{q}, Sₚ and S_{q} over the rings, one obtains:

$$\begin{matrix}\overline{P} ( {x}_{0} , {x}_{1} , {x}_{2} ) = 4267 * p ( {x}_{0} , {x}_{1} , {x}_{2} ) mod 6797 \\ = ( 5211 + 4418 {x}_{0} + 6155 {{x}_{0}}^{2} ) {x}_{1} + ( 2681 + 6155 {x}_{0} + 151 {{x}_{0}}^{2} ) {x}_{2}\end{matrix}$$

$$\begin{matrix}\overline{Q} ( {x}_{0} , {x}_{1} , {x}_{2} ) = 6475 * q ( {x}_{0} , {x}_{1} , {x}_{2} ) mod 7123 \\ = ( 5827 + 1291 {x}_{0} + 643 {{x}_{0}}^{2} ) {x}_{1} + ( 7118 + 5827 {x}_{0} + 6470 {{x}_{0}}^{2} ) {x}_{2}\end{matrix}$$

Then, choosing the Barrett parameter R=2²⁴, and choosing β=1 for simplicity, one obtains the data elements of the sender's public key 50 as follows:

$${s}_{p} = 11 ,$$

$${s}_{q} = 12 ,$$

$${p}^{′} = [ \begin{matrix}11 & 3 \\ 11 & 6 \\ 6 & 8\end{matrix} ]$$

$${q}^{′} = [ \begin{matrix}3 & 7 \\ 4 & 3 \\ 6 & 9\end{matrix} ]$$

$$μ = [ \begin{matrix}12862449 & 6617583 \\ 10905066 & 15192550 \\ 15192550 & 372717\end{matrix} ]$$

$$v = [ \begin{matrix}13724671 & 16765439 \\ 3040767 & 13724671 \\ 1514495 & 15239167\end{matrix} ]$$

### Signing

Assuming now that the value (or the hashed value) of the digital asset is x₀=9, the signing process involves the following:

$$Choose a random α in GF ( 13 ) ; in this case let α = 1 ;$$

$$Evaluate F = {{R}_{q}}^{- 1} \times [ f ( {x}_{0} ) mod p ] mod {S}_{q} , \\ which gives = {6475}^{- 1} \times [ 4 + 9 * 9 mod 13 ] mod 7123 = 5683 ;$$

$$Evaluate H = {{R}_{p}}^{- 1} \times [ h ( {x}_{0} ) mod p ] mod {S}_{p} , \\ which gives = {4267}^{- 1} \times [ 10 + 7 * 9 mod 13 ] mod 6797 = 5357.$$

The resulting signature for this digital asset x₀ is therefore {F, H}={5683, 5357}.

### Verification

After receiving the signed message (including the digital asset x₀ and the digital signature {F, H}) from the sending computer 10, the verification computer 20 implements the verification process, which includes first evaluating Vᵢⱼ(F) and Uᵢⱼ(H), i.e., the coefficients of the verification polynomials, as per (EQ. 10U) and (EQ. 10V), based on the aforementioned data elements of the sender's public key and and the digital signature {F H}:

$$U = [ \begin{matrix}9 & 4 \\ 7 & 10 \\ 10 & 12\end{matrix} ]$$

$$V = [ \begin{matrix}1 & 12 \\ 11 & 1 \\ 5 & 6\end{matrix} ]$$

With these coefficients, one can express both sides of (EQ. 8) as follows, for j=1 to m:

| j | Σᵢ₌₀^{n+λ} Uᵢⱼ(H)x₀ⁱ mod p | Σᵢ₌₀^{n+λ} Vᵢⱼ(F)x₀ⁱ mod p |
|---|---|---|
| 1 | (9 + 7x₀ + 10x₀²) mod 13 | (1 + 11x₀ + 5x₀²) mod 13 |
| 2 | (4 + 10x₀ + 12x₀²) mod 13 | (12 + x₀ + 6x₀²) mod 13 |

Plugging in x₀=9, i.e., the value of the digital asset in this simplified numerical example, one obtains:

| j | Σᵢ₌₀^{n+λ} Uᵢⱼ(H)x₀ⁱ mod p | Σᵢ₌₀^{n+λ} Vᵢⱼ(F)x₀ⁱ mod p |
|---|---|---|
| 1 | 882 mod 13 = 11 | 505 mod 13 = 11 |
| 2 | 1066 mod 13 = 0 | 507 mod 13 = 0 |

Given that there is identity of both sets of coefficients for all values of j=1 to m, verification is therefore deemed successful. It is noted that both sides of equation (EQ. 8) will be identical irrespective of the values of the noise variables xⱼ, j=1 to m.

### Security Analysis

For a detailed security analysis, the reader is referred to Section 5 of Kuang et al., Homomorphic polynomial public key with the Barrett transformation for digital signature, Academia Quantum, https://doi.org/10.20935/AcadQuant7353, published Sep. 27, 2024, hereby incorporated by reference herein.

### Benchmark Performance

A performance evaluation of the inventive digital signature and verification method disclosed herein was carried out using the SUPERCOP benchmarking tool (see https://bench.cr.yp.to). All embodiments were configured to meet NIST security levels I, III, and V, which correspond to the difficulty of breaking 128, 192, and 256-bit AES encryption. The benchmarking was conducted on a 16-core Intel i7-10700 CPU running at 2.90 GHz.

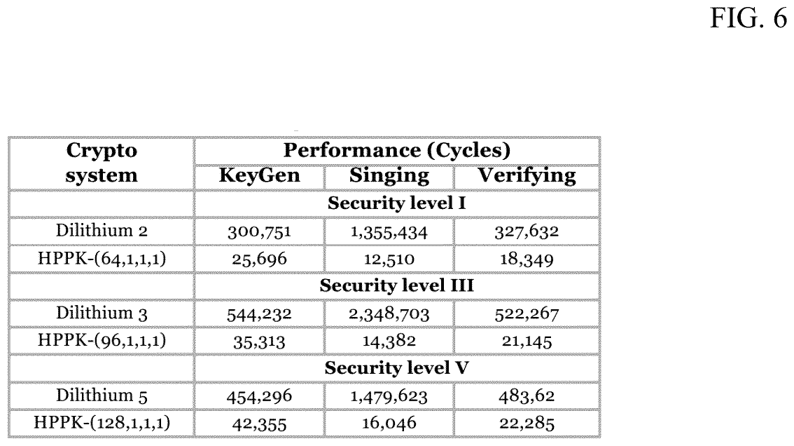

FIG. 6 compares the performance of the inventive digital signature and verification method with the NIST-standardized Dilithium scheme across these three security levels. The disclosed digital signature and verification method was configured to have parameters n=λ=m=1 and a Barrett parameter K=L+32 bits.

For key generation, the inventive digital signature and verification method demonstrates a clear advantage over the Dilithium schemes at all security levels. At security level I, the inventive digital signature and verification method requires only 25,696 cycles, significantly fewer than the 300,751 cycles required by Dilithium 2. This efficiency continues at security levels III and V, where inventive digital signature and verification method requires 35,313 and 42,355 cycles, respectively, compared to 544,232 cycles for Dilithium 3 and 454,296 cycles for Dilithium 5. This shows that inventive digital signature and verification method can generate keys more rapidly, which is crucial for environments where key generation speed is a key factor.

In terms of signing performance, the inventive digital signature and verification method also outperforms the Dilithium schemes. At security level I, the inventive digital signature and verification method performs signing in just 12,510 cycles, while Dilithium 2 requires 1,355,434 cycles. This trend is consistent across higher security levels, with the inventive digital signature and verification method taking 14,382 cycles at security level III compared to 2,348,703 cycles for Dilithium 3, and 16,046 cycles at security level V compared to 1,479,623 cycles for Dilithium 5. These results highlight the superior signing speed of the inventive digital signature and verification method, which benefits applications requiring rapid signing.

Regarding verification, the inventive digital signature and verification method again shows superior performance. At security level I, verification is completed in 18,349 cycles by the inventive digital signature and verification method, compared to 327,632 cycles for Dilithium 2. This performance advantage holds across the security levels: the inventive digital signature and verification method needs 21,145 cycles at security level III versus 522,267 cycles for Dilithium 3, and 22,285 cycles at security level V compared to 483,624 cycles for Dilithium 5. The reduced verification times of the inventive digital signature and verification method make it particularly advantageous for scenarios requiring quick verification.

Overall, the inventive digital signature and verification method demonstrates more efficient performance in key generation, signing, and verification compared to the Dilithium scheme, making it a compelling alternative for high-performance cryptographic applications.

### General Remarks

In some embodiments, rather than use the digital asset x₀ to generate a digital signature, the signing computer 10 may use a hash of the digital asset x₀, and the same hash function would be applied to the digital asset x₀ by the verification computer 20.

Those skilled in the art will appreciate that the entities referred to above as “signing computer”, “verification computer”, “key generation entity” and the like, which carry out the various signing and verification methods and protocols described above, can be realized by computing apparatuses executing computer-readable program instructions stored on non-transitory computer-readable media. Such computing apparatuses could be any of a smartphone, laptop, desktop computer, tablet, mainframe, vehicle ECU (electronic control unit) or IoT (Internet-of-Things) device, to name a few non-limiting possibilities.

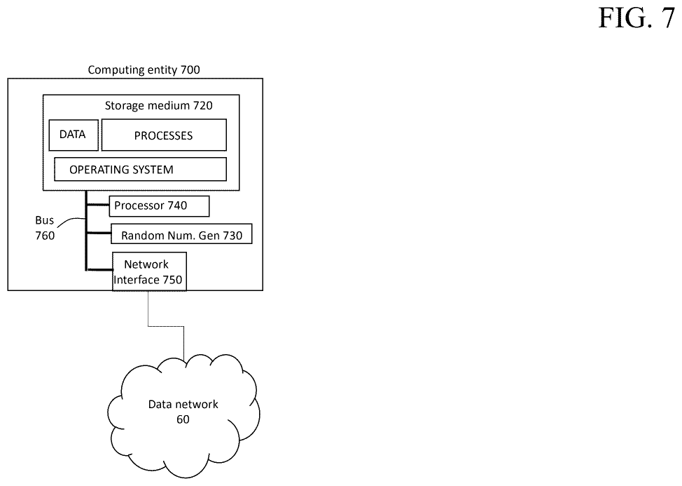

In an embodiment, and with reference to FIG. 7, there is provided a computing entity 700 that can be an implementation of the signing computer 10, the verification computer 20 and/or the key generation computer 15. The computing entity 700 includes a computer-readable storage medium 720, which can be a tangible device capable of storing program instructions for use by a processor 740. The computer-readable storage medium 720 may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium 720 includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, does not include transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The program instructions can be downloaded to the computer-readable storage medium 720 from an external computer or external storage device via the data network 60, which can include the Internet, a local area network, a wide area network and/or a wireless network. The data network 60 may comprise copper transmission cables, optical transmission fibers, wireless transmission, routers, firewalls, switches, gateway computers and/or edge computers. A network adapter card or network interface 750 in the computing entity 700 receives program instructions over the data network 60 and forwards them to the computer-readable storage medium 720 for storage and execution by the processor 740. Execution of the program instructions by the processor 740 results in the computing entity 700 carrying out general processes (such as an operating system) as well as application-specific processes (such as the key generation process 200, the signing process 300, the verification process 400, as the case may be) and other processes depending on operational requirements.

A user interface 710 is also connected to the processor 740 and may include various input and/or output devices, as well as program instructions that interact with the various input and/or output devices so as to elicit input from a user and provide output to the user via the input and/or output devices. The user interface 710 may be a graphical user interface for interfacing with the user. A bus architecture 760 may interconnect the user interface 710, the processor 740, the memory 720 and the network interface 750.

A pseudo-random number generator 730 may also be implemented by the computing entity 700 and may be interconnected to other components of the computing entity 700 by the bus architecture 760. In other embodiments, the pseudo-random number generator 730 may be implemented in software by the processor 740 executing program code stored in the memory 720.

The various program instructions referred to above may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In some embodiments, electronic circuitry including, for example, programmable logic circuitry, field-programmable gate arrays (FPGA), or programmable logic arrays (PLA) may execute the program instructions by utilizing state information to personalize the electronic circuitry, in order to carry out aspects of the present disclosure.

Aspects of the present disclosure are described herein with reference to flowcharts and block diagrams of methods and apparatus (systems), according to various embodiments. It will be understood that each block of the flowcharts and block diagrams, and combinations of such blocks, can be implemented by execution of the program instructions. Namely, the program instructions, which are read and processed by the processor 530 of the computing apparatus 510, direct the processor 530 to implement the functions/acts specified in the flowchart and/or block diagram block or blocks. It will also be noted that each block of the flowcharts and/or block diagrams, and combinations of such blocks, can also be implemented by special purpose hardware-based systems that perform the specified functions or acts or carry out combinations of special purpose hardware and computer instructions.

The flowcharts and block diagrams illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the drawings. For example, two blocks shown in succession may, in fact, be executed substantially concurrently, or the blocks may sometimes be executed in the reverse order, depending upon the functionality involved.

The descriptions of the various embodiments of the present disclosure have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It should be appreciated that throughout the specification, discussions utilizing terms such as “processing”, “computing”, “calculating”, “determining”, “analyzing” or the like, can refer to the action and/or processes of a computer or computing system, or similar electronic computing device, that manipulate and/or transform data represented as physical, such as electronic, quantities into other data similarly represented as physical quantities.

As used herein, unless otherwise specified, the use of the ordinal adjectives “first”, “second”, “third”, etc., to describe a common object or step, merely indicate that different instances of like objects or steps are being referred to, and are not intended to imply that the objects or steps so described must be in a given sequence, either temporally, spatially, in ranking, or in any other manner.

It is noted that various individual features may be described only in the context of one embodiment. The particular choice for description herein with regard to a single embodiment is not to be taken as a limitation that the particular feature is only applicable to the embodiment in which it is described. Various features described in the context of one embodiment described herein may be equally applicable to, additive, or interchangeable with other embodiments described herein, and in various combinations, groupings or arrangements. In particular, use of a single reference numeral herein to illustrate, define, or describe a particular feature does not mean that the feature cannot be associated or equated to another feature in another drawing figure or description.

Also, when the phrase “at least one of C and D” is used, this phrase is intended to and is hereby defined as a choice of C or D or both C and D, which is similar to the phrase “and/or”. Where more than two variables are present in such a phrase, this phrase is hereby defined as including only one of the variables, any one of the variables, any combination of any of the variables, and all of the variables.

The foregoing description and accompanying drawings illustrate the principles and modes of operation of certain embodiments. However, these embodiments should not be considered limiting. Additional variations of the embodiments discussed above will be appreciated by those skilled in the art and the above-described embodiments should be regarded as illustrative rather than restrictive. Accordingly, it should be appreciated that variations to those embodiments can be made by those skilled in the art without departing from the scope of the invention.

What is claimed is:

1. A method of operating a computing apparatus for verifying authenticity of digital cryptographic communications received from a sending device over a data network, the method comprising:
receiving a signed message from the sending device, the signed message including (i) a digital asset represented by an integer x₀ and (ii) a signature, the signature including data elements represented by integers F and H;
obtaining a public key associated with a private key that is unknown to the computing apparatus, the public key including data elements represented by integers sₚ, s_{q}, pᵢⱼ′, qᵢⱼ′, μᵢⱼ and vᵢⱼ, i=0 to n+λ, j=1 to m, with λ, n and m being predetermined integers stored in a memory of the computing apparatus;
verifying, based on the signature, the public key and the digital asset, whether a validation equation holds true, wherein the validation equation comprises:
$${\sum }_{i = 0}^{n + λ} {U}_{ij} ( H ) {{x}_{0}}^{i} = {\sum }_{i = 0}^{n + λ} {V}_{ij} ( F ) {{x}_{0}}^{i} , j = 1 to m , where$$
$${U}_{ij} ( H ) = {{Hp}^{′}}_{ij} - {s}_{p} ⌊ H {μ}_{ij} / R ⌋ mod p$$
$${V}_{ij} ( F ) = {{Fq}^{′}}_{ij} - {s}_{q} ⌊ {Fv}_{ij} / R ⌋ mod p ;$$
wherein p is a predetermined integer stored in the memory of the computing apparatus and wherein R is predetermined power of 2 stored in the memory of the computing apparatus;
in case the validation equation holds true for all values of j=1 to m, concluding that the signature was derived from the digital asset and the private key, whereby the signature is considered authentic;
outputting on a network or storing in the memory of the computing apparatus an indication that the signature is considered authentic.

2. The method of claim 1, in case the validation equation does not holds true for at least one value of j=1 to m, concluding that the signature was not derived from the digital asset and the private key, whereby the signature is considered forged.

3. The method of claim 1, carried out for each digital asset forming a segment of a hashed original message.

4. The method of claim 1, wherein the predetermined integer p is selected to be a prime number.

5. The method of claim 1, wherein R is a base for a Barrett reduction algorithm and μᵢⱼ and vᵢⱼ are Barrett parameters.

6. The method of claim 5, wherein R=2^{K}, where K>>log₂n or K>>l_{S}.

7. The method of claim 1, wherein the signed message further includes the public key.

8. The method of claim 1, further comprising obtaining the public key over the data network from the sending device.

9. The method of claim 1, further comprising obtaining the public key over the data network from a key generation computer.

10. A non-transitory computer-readable medium storing computer-readable instructions which, when read and executed by at least one processing unit associated with a computing apparatus, cause the processing unit to carry out the method of claim 1.

11. A computing apparatus, comprising:
a memory storing computer-readable instructions;
a processor coupled to the memory and configured to read and execute the computer-readable instructions to carry out a method for verifying authenticity of digital cryptographic communications received from a sending device over a data network, the method comprising:
receiving a signed message from the sending device, the signed message including (i) a digital asset represented by an integer x₀ and (ii) a signature, the signature including data elements represented by integers F and H;
obtaining a public key associated with a private key that is unknown to the computing apparatus, the public key including data elements represented by integers sₚ, s_{q}, pᵢⱼ′, qᵢⱼ′, μᵢⱼ and vᵢⱼ, i=0 to n+λ, j=1 to m, with λ, n and m being predetermined integers stored in a memory of the computing apparatus;
verifying, based on the signature, the public key and the digital asset, whether a validation equation holds true, wherein the validation equation comprises:
$${\sum }_{i = 0}^{n + λ} {U}_{ij} ( H ) {{x}_{0}}^{i} = {\sum }_{i = 0}^{n + λ} {V}_{ij} ( F ) {{x}_{0}}^{i} , j = 1 to m , where$$
$${U}_{ij} ( H ) = {{Hp}^{′}}_{ij} - {s}_{p} ⌊ H {μ}_{ij} / R ⌋ mod p$$
$${V}_{ij} ( F ) = {{Fq}^{′}}_{ij} - {s}_{q} ⌊ {Fv}_{ij} / R ⌋ mod p ;$$
wherein p is a predetermined integer stored in the memory of the computing apparatus and wherein R is predetermined power of 2 stored in the memory of the computing apparatus;
in case the validation equation holds true for all values of j=1 to m, concluding that the signature was derived from the digital asset and the private key, whereby the signature is considered authentic;
outputting on a network or storing in the memory of the computing apparatus an indication that the signature is considered authentic.

12. A method of operating a computing apparatus for transmitting cryptographic communications to a verification device over a data network, the method comprising:
obtaining a digital asset x₀;
selecting a variable a belonging to a finite field GFₚ, wherein p is a predetermined integer stored in a memory of the computing apparatus;
computing a signature that includes the data elements F and H, where:
$$F = {{R}_{q}}^{- 1} \times [ α f ( {x}_{0} ) mod p ] mod {S}_{q}$$
$$H = {{R}_{p}}^{- 1} \times [ α h ( {x}_{0} ) mod p ] mod {S}_{p} ,$$
wherein
f(·) is a first polynomial;
h(·) is a second polynomial;
Rₚ and Sₚ are a first co-prime pair; and
R_{q} and S_{q} are a second co-prime pair; and
transmitting a signed message to the second computing apparatus over a communication channel, wherein the signed message includes the digital asset x₀ and the signature.

13. The method defined in claim 12, wherein the signature is a lossless combination of data elements F and H.

14. The method defined in claim 12, wherein the signature is authenticated by:
obtaining a public key that includes data elements represented by integers sₚ, s_{q}, pᵢⱼ′, qᵢⱼ′, μᵢⱼ and vᵢⱼ, i=0 to n+λ, j=1 to m; and
verifying whether a validation equation holds true, wherein the validation equation comprises:
$${\sum }_{i = 0}^{n + λ} {U}_{ij} ( H ) {{x}_{0}}^{i} = {\sum }_{i = 0}^{n + λ} {V}_{ij} ( F ) {{x}_{0}}^{i} , j = 1 to m , where$$
$${U}_{ij} ( H ) = {{Hp}^{′}}_{ij} - {s}_{p} ⌊ H {μ}_{ij} / R ⌋ mod p$$
$${V}_{ij} ( F ) = {{Fq}^{′}}_{ij} - {s}_{q} ⌊ {Fv}_{ij} / R ⌋ mod p ;$$
wherein λ, n and m are predetermined integers and R is predetermined power of 2;
and wherein the signature is considered authentic in case the validation equation holds true for all values of j=1 to m.

15. The method defined in claim 12,
wherein f(·), h(·), Rₚ, Sₚ, R_{q} and S_{q} are elements of a private key;
wherein the signature is authenticated by obtaining a public key associated with the private key and verifying whether a validation equation involving the digital asset, the signature and the public key holds true.

16. The method of claim 15, further comprising sending the public key together with the digital asset and the signature.

17. The method of claim 15, carried out for each digital asset forming a segment of a hashed original message.

18. The method of claim 15, further comprising withholding the private key from the verification device.

19. The method of claim 12, wherein the bit length of x, does not exceed the bit length of p and p is prime.

20. The method of claim 12, wherein the variable a is arbitrarily selected in the finite field GFₚ.

21. The method of claim 12, wherein the first polynomial function f(·) and the second polynomial function h(·) each have an order of 3 or less.

22. A non-transitory computer-readable medium storing computer-readable instructions which, when read and executed by at least one processing unit associated with a computing apparatus, cause the processing unit to carry out the method of claim 12.

23. A computing apparatus, comprising:
a memory storing computer-readable instructions;
a processor coupled to the memory and configured to read and execute the computer-readable instructions to carry out a method for transmitting cryptographic communications to a verification device over a data network, the method comprising:
obtaining a digital asset xo;
selecting a variable α belonging to a finite field GFₚ, wherein p is a predetermined integer stored in a memory of the computing apparatus;
computing a signature that includes the data elements F and H, where:
$$F = {{R}_{q}}^{- 1} \times [ α f ( {x}_{0} ) mod p ] mod {S}_{q}$$
$$H = {{R}_{p}}^{- 1} \times [ α h ( {x}_{0} ) mod p ] mod {S}_{p} ,$$
wherein
f(·) is a first polynomial;
h(·) is a second polynomial;
Rₚ and Sₚ are a first co-prime pair; and
R_{q} and S_{q} are a second co-prime pair; and
transmitting a signed message to the second computing apparatus over a communication channel, wherein the signed message includes the digital asset x₀ and the signature.

24. A process for operating a computing apparatus to generate a private-public key pair, the private key for use in a signing process for creating a signed message from a digital asset, the signed message including the digital asset and a signature, and the public key for use in a verification process for authenticating the signature based on the public key, the signature and the digital asset, the process comprising:
a) selecting coefficients of a multivariate base polynomial B(x₀, x₁, . . . , xₘ) of order n for x₀, where n and m are selected integers stored in the memory of the computing apparatus;
b) selecting polynomials f(·) and h(·) of degree λ, where λ is a selected integer stored in the memory of the computing apparatus;
c) constructing a pair of polynomials, p(x₀, x₁, . . . , xₘ) and q(x₀, x₁, . . . , xₘ), by multiplying the base polynomial B(x₀, x₁, . . . , xₘ) with the polynomials f(·) and h(·), respectively:
$$p ( {x}_{0} , {x}_{1} , ... , {x}_{m} ) = B ( {x}_{0} , {x}_{1} , ... , {x}_{m} ) f ( {x}_{0} ) = {\sum }_{j = 1}^{m} {p}_{j} ( {x}_{0} ) {x}_{j}$$
$$q ( {x}_{0} , {x}_{1} , ... , {x}_{m} ) = B ( {x}_{0} , {x}_{1} , ... , {x}_{m} ) h ( {x}_{0} ) = {\sum }_{j = 1}^{m} {q}_{j} ( {x}_{0} ) {x}_{j}$$
$$where {p}_{j} ( {x}_{0} ) = {\sum }_{i = 0}^{n + λ} {p}_{ij} {{x}_{0}}^{i} and {q}_{j} ( {x}_{0} ) = {\sum }_{i = 0}^{n + λ} {q}_{ij} {{x}_{0}}^{i}$$
such that pᵢⱼ and qᵢⱼ are defined as follows:
$${p}_{ij} = {\sum }_{s + t = i} {f}_{s} {b}_{tj}$$
$${q}_{ij} = {\sum }_{s + t = i} {h}_{s} {b}_{tj}$$
d) selecting two co-prime pairs (sₚ, Rp) and (s_{q}, Rq)
e) computing the following:
Pᵢⱼ=Rₚ pᵢⱼ mod Sₚ
Qᵢⱼ=R_{q} qᵢⱼ mod S_{q}
f) creating the private key as including the following data elements:
the coefficients of the polynomial f(·)
the coefficients of the polynomial h(·)
sₚ, s_{q}, Rₚ and R_{q}
g) composing the public key as including the following data elements:
$${s}_{p} = β {S}_{p} mod p$$
$${s}_{q} = β {S}_{q} mod p$$
$${{p}^{′}}_{ij} = β {P}_{ij} mod p$$
$${{q}^{′}}_{ij} = β {Q}_{ij} mod p$$
$${μ}_{ij} = ⌊ \frac{{RP}_{ij}}{{S}_{p}} ⌋$$
$${v}_{ij} = ⌊ \frac{{RQ}_{ij}}{{S}_{q}} ⌋$$
where:
R is a power of 2, and
β is arbitrarily selected over the finite field GF(p).

25. The process of claim 24, wherein Sₚ and S_{q} are selected to have a bit length lₛ>=2*log₂p+log₂[m(n+λ+1)].

26. The process of claim 25, wherein R=2^{K} and K is selected to be >>lₛ.

27. The process of claim 24, further comprising storing the private key and the public key in memory of the computing apparatus.

28. The process of claim 24, further causing the private key to be securely stored in a memory of a computing device for execution of the signing process.

29. The process of claim 28, further causing the public key to be made available to a second computing device for execution of the verification process.

30. A non-transitory computer-readable medium storing computer-readable instructions which, when read and executed by at least one processing unit associated with a computing apparatus, cause the processing unit to carry out the method of claim 24.
